(19) United States
(12) Patent Application Publication
(10) Pub. No.: US 2010/0285370 A1
(43) Pub. Date: Nov. 11, 2010

(54) ELECTRODE GROUP WITH DESIRABLE HEAT DISSIPATING PERFORMANCE FOR USE IN LITHIUM ION BATTERIES

(76) Inventors: Heng-Tao Xia, Dongguan City (CN); Feng-Gang Zhao, Guangzhou City (CN); Rui Xu, Dongguang City (CN); Kai-Gui Cai, Dongguan City (CN); Kun-qing Zhu, Dongguan City (CN); Wei Chen, Dongguan City (CN); Yu-qun Zeng, Dongguan City (CN)

Correspondence Address: QUINN LAW GROUP, PLLC, 39555 ORCHARD HILL PLACE, SUITE # 520, NOVI, MI, 48375, US

(21) Appl. No.: 12/775,158

(22) Filed: May 6, 2010

(30) Foreign Application Priority Data
May 7, 2009 (CN) CN 200920056126.5

(51) Int. Cl. H01M 2/16

(52) U.S. Cl. 429/246

(57) ABSTRACT

An electrode group for use in lithium ion batteries includes an anode plate, a cathode plate and a separator disposed between the anode plate and the cathode plate. The anode plate includes an anode current collector and an anode film containing anode active material formed on the anode current collector. The cathode plate includes a cathode current collector and a cathode film containing cathode active material formed on the cathode current collector. The anode current collector is formed with a number of anode extending portions extending along a width direction thereof and the anode extending portions are coupled together to form an anode lead. The cathode current collector is formed with a number of cathode extending portions extending along a width direction thereof and the cathode extending portions are coupled together to form a cathode lead.

### CROSS-REFERENCE TO RELATED APPLICATIONS

The present invention claims priority to Chinese Patent Application No. CN 200920056126.5 filed on May 7, 2009, which is incorporated by reference herein in its entirety.

### FIELD OF THE INVENTION

The present invention generally relates to lithium ion batteries and, more specifically, relates to an electrode group with desirable heat dissipating performance for use in lithium ion batteries.

### BACKGROUND OF THE INVENTION

Conventionally, lithium ion batteries having low internal resistance and high power generally includes a number of battery cells connected to each other in parallel. Each battery cell includes a stacked electrode group or a wound electrode group.

The stacked electrode group can remarkably reduce internal resistance of the lithium ion battery. However, it is very difficult to accurately register an anode plate with a corresponding cathode plate. Additionally, the heat generated during the work of each battery cell can not be dissipated timely and quickly.

As to the wound electrode group, the anode plate is provided with a number of anode leads soldered thereon. The cathode plate is soldered with a number of cathode leads. The anode leads are electrically connected to each other in parallel. The cathode leads are also electrically connected one another in parallel. Consequently, the internal resistance of the lithium ion battery can be considerably reduced. However, the high power property of the lithium ion battery can hardly meet different requirements in actual use. Additionally, due to strict requirement to the consistency of each battery cell, the manufacturing process is pretty complex.

What is needed, therefore, is to provide an electrode group with desirable heat dissipating performance for use in lithium ion batteries.

### SUMMARY OF THE INVENTION

One objective of the present invention is to provide an electrode group with desirable heat dissipating performance for use in lithium ion batteries.

According to one embodiment of the present invention, an electrode group with desirable heat dissipating performance for use in lithium ion batteries includes an anode plate, a cathode plate and a separator disposed between the anode plate and the cathode plate. The anode plate includes an anode current collector and an anode film containing anode active material formed on the anode current collector. The cathode plate includes a cathode current collector and a cathode film containing cathode active material provided on the cathode current collector. The anode current collector is formed with a number of anode extending portions extending along a width direction thereof, and the anode extending portions are coupled together to form an anode lead. The cathode current collector is provided with a number of extending portions extending along a width direction thereof, and the cathode extending portions are coupled together to form an cathode lead.

Preferably, position and size of the anode extending portions and the cathode extending portions can be adjusted according to different design requirements.

Preferably, the anode lead and the cathode lead are seated at the same side of the electrode group.

Preferably, the anode lead and the cathode lead are situated at two opposite sides of the electrode group.

Preferably, the anode active material of the anode plate is Li₄Ti₅O₁₂.

The electrode group in accordance with the present invention at least has the following advantages over the prior art.

The anode current collector and the cathode current collector each is formed with a number of extending portions extending in a width direction thereof. The anode extending portions can be coupled together to form an anode lead. The cathode extending portions can be coupled together to form a cathode lead. When the anode lead and the cathode lead are securely fixed to corresponding positive plate and the negative plate, most of the anode plate and the cathode plate are very close to the positive plate and the negative plate along a vertical direction and, therefore, internal resistance of the lithium ion battery can be remarkably reduced and the output current of the lithium ion battery can be improved remarkably.

The lithium ion battery adopting the electrode group in accordance with the present invention can remarkably reduce the internal resistance of the lithium ion battery, improve the discharge voltage platform as well as the discharge current of the lithium ion battery, reduce the charge and discharge temperature of the lithium ion battery, improve electrochemical properties and the output power of the lithium ion battery.

The anode current collector and the cathode current collector of the electrode group according to the present invention can take part in dissipating heat of the lithium ion battery. Additionally, the anode current collector and the cathode current collector are both formed as a whole, which can facilitate heat transfer and further realize quick and even heat dissipation of the lithium ion battery.

The anode extending portions and the cathode extending portions according to the electrode group of the present invention can be configured to be situated at two opposite sides of the electrode group. Via adjusting the space between the extending portions, the anode extending portions can be coupled together to form an anode lead and the cathode extending portions can be connected to each other to form a cathode lead. After the anode lead and the cathode lead are fixed to corresponding positive plate and the negative plate, the anode plate and the cathode plate are very close to corresponding positive plate and the negative plate and, therefore, internal resistance of the lithium ion battery can be reduced remarkably.

The anode extending portions and the cathode extending portions of the lithium ion battery can be seated at same side of the electrode group. Via adjusting the space between the extending portions, the anode extending portions can be coupled to each other to form an anode lead and the cathode extending portions can be coupled together to form a cathode lead. After the anode lead and the cathode lead are fixed to a corresponding positive plate or negative plate, the anode plate and the cathode plate are close to corresponding positive plate and the negative plate and, therefore, the internal resistance of the lithium ion battery can be reduced remarkably.

Other advantages and novel features will be drawn from the following detailed description of preferred embodiments with the attached drawings, in which:

### BRIEF DESCRIPTION OF THE DRAWINGS

FIG. 1 depicts an illustrative side view of a cathode plate for use in an electrode group in accordance with one embodiment of the present invention;

FIG. 2 depicts another illustrative side view of a cathode plate for use in an electrode group in accordance with one embodiment of the present invention;

FIG. 3 depicts an exemplary side view of an anode plate for use in an electrode group;

FIG. 4 depicts an exemplary cross-sectional view of an electrode group in accordance with one embodiment of the present invention;

FIG. 5 depicts an exemplary side view of a wound battery cell according to a first embodiment of the present invention; and

FIG. 6 depicts an exemplary side view of a wound battery cell according to a second embodiment of the present invention.

### DETAILED DESCRIPTION OF THE INVENTION

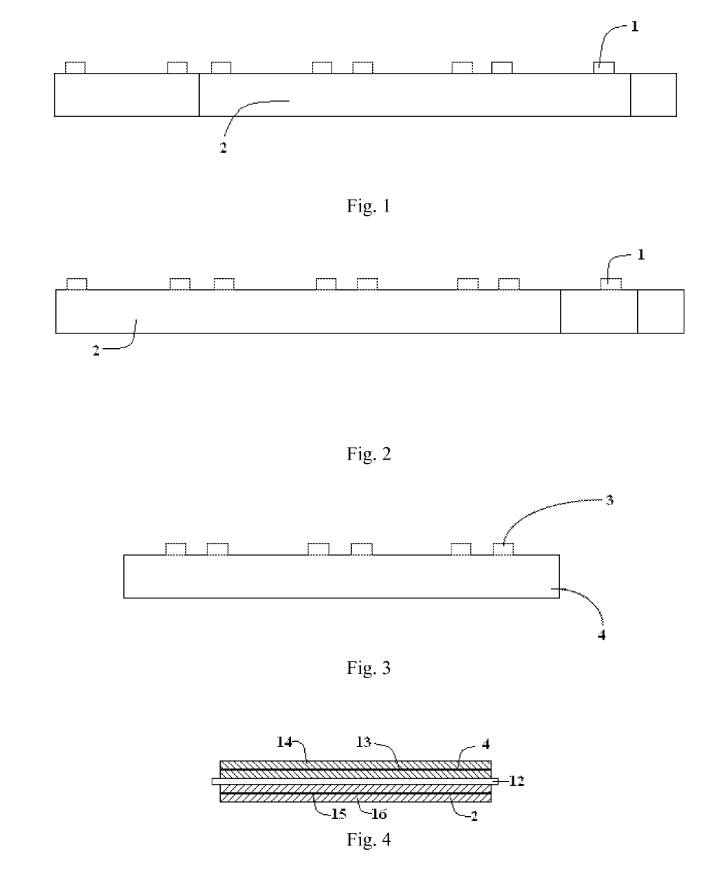

FIG. 1 to FIG. 4 illustrates an electrode group with desirable heat dissipating performance in accordance with one embodiment of the present invention, especially for use in an oval lithium ion battery or a prismatic lithium ion battery. The electrode group includes an anode plate 4, a cathode plate 2 and a separator 12 disposed between the anode plate 4 and the cathode plate 2. The anode plate 4 has an anode current collector 13 and an anode film 14 containing anode active material formed on the anode current collector. The cathode plate 2 includes a cathode current collector 15 and a cathode film 16 containing cathode active material formed on the cathode current collector 15. The cathode current collector 15 is integrally formed with a number of cathode extending portions 1 extending along a width direction thereof, while the anode current collector 13 is also integrally formed with a number of anode extending portions 3 extending along a width direction thereof.

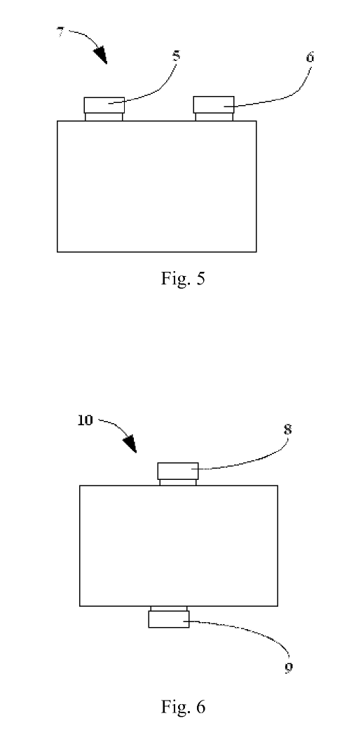

As clearly shown in FIG. 5, after the anode plate 4, the cathode plate 2 and the separator 12 are stacked and spirally wound together to form a battery cell 7, the anode extending portions 2 formed on the anode plate 4 are electrically coupled to each other to form an anode lead 5. The cathode extending portions 3 formed on the cathode plate 1 are electrically coupled to each other to form a cathode lead 6. In the illustrated embodiment, the anode lead 5 and the cathode lead 6 are both seated at the same side of the battery cell 7, i.e. both situated on the upper side of the battery cell 7. The battery cell 7 is electrically connected to an external circuit via the anode lead 5 and the cathode lead 6.

In the illustrated embodiment, the design capacity of the battery cell 7 is 10 Ah. The cathode active material is Li₄Ti₅O₁₂. The cathode active material is mixed with a predetermined amount of conductive agent and bonding agent to obtain a cathode paste. The cathode paste is coated on the cathode current collector 15 to form the cathode plate 2.

The anode active material is complex metal oxide, such as LiNiCoMnO₂ and LiMn₂O₄. The anode active material is mixed with a predetermined amount of conductive agent and bonding agent, so as to obtain an anode paste. The anode paste is coated on the anode current collector 13 to form the anode plate 4.

The separator 12 disposed between the anode plate 4 and the cathode plate 2 is made from PP, PE or polymer separating film made from PP.

The electrolyte is a solution system containing EC, PC cyclic ester and chain ester of EMC, DEC and DMC. The lithium salt is LiPF₆.

Due to the arrangement of the anode extending portions 1 and the cathode extending portions 3, the lithium ion battery having the electrode group according to the present invention has desirable power property, cyclic property and security property. The internal resistance of the lithium ion battery in accordance with the present invention is about 3.0 milliohm. The capacity of the battery cell according to the present invention can reach 90% when discharges at 10 C. After 1000 circles under 2 C/2 C 100% SOC, the capacity retention maintains above 80%, which can meet the requirement of high power. The temperature raise is less than 10 degree when circles at 6 C, which indicates that the battery cell has desirable heat dissipating performance.

FIG. 6 illustrates a second embodiment of the electrode group according to the present invention. Unlike the first embodiment of the present invention, the anode lead 8 and the cathode lead 9 in the second embodiment of the present invention are seated at two opposite sides of the battery cell 10, i.e. one of the anode lead 8 and the cathode lead 9 is seated at upper side of the battery cell 10, while the other is seated at lower side of the battery cell 10. Other structures of the lithium ion battery in the second embodiment of the present invention are the same as those illustrated in the first embodiment except for the sizes of the anode plate and the cathode plate.

In the illustrated embodiment, the design capacity of the battery cell is 3.5 Ah. The cathode active material is Li₄Ti₅O₁₂. The cathode active material is mixed with a predetermined amount of conductive agent and bonding agent to obtain a cathode paste. The cathode paste is coated on the cathode current collector to form the cathode plate.

The anode active material is complex metal oxide, such as LiNiCoMnO₂ and LiMn₂O₄. The anode active material is mixed with a predetermined amount of conductive agent and bonding agent, to obtain an anode paste. The anode paste is then coated on the anode current collector to form the anode plate.

The separator disposed between the anode plate and the cathode plate is made from PP, PE or polymer separating film made from PP.

The electrolyte is a solution system containing EC, PC cyclic ester and chain ester of EMC, DEC and DMC. The lithium salt is LiPF₆.

Due to the arrangement of the anode extending portions and the cathode extending portions, the lithium ion battery having the electrode group in accordance with the present invention has desirable power property, cyclic property and security property. The internal resistance of the lithium ion battery is about 1.4 milliohm. The capacity of the battery cell of the present invention can reach 90% when charges at 20 C and reach 95% when discharges at 20 C. After 4000 circles under 5 C/5 C 100% SOC, the capacity retention maintains above 80%.

Additionally, in the security test, there is no noticeable temperature raise in the nail-needle test. The highest overcharge temperature is about 73° C. when overcharges at 1 C/10V. In the thermal case test at 200° C., there is no explosion, smoke and leakage.

While the present invention has been illustrated by the above description of the preferred embodiment thereof, while the preferred embodiment has been described in considerable detail, it is not intended to restrict or in any way limit the scope of the appended claims to such details. Additional advantages and modifications within the spirit and scope of the present invention will readily appear to those skilled in the art. Therefore, the present invention is not limited to the specific details and the illustrative examples shown and described.

What is claimed is:

1. An electrode group for use in lithium ion batteries, comprising:
an anode plate having an anode current collector and an anode film containing anode active material formed on the anode current collector;
a cathode plate having a cathode current collector and a cathode film containing cathode active material formed on the cathode current collector; and
a separator disposed between the anode plate and the cathode plate;
wherein the anode current collector is provided with a plurality of anode extending portions extending along a width direction thereof, and the anode extending portions are coupled together to form an anode lead; and
the cathode current collector is formed with a plurality of cathode extending portions extending along a width direction thereof, and the cathode extending portions are coupled together to form a cathode lead.

2. The electrode group as claimed in claim 1, wherein the anode lead and the cathode lead are situated at same side of the electrode group.

3. The electrode group as claimed in claim 1, wherein the anode lead and the cathode lead are seated at two opposite sides of the electrode group.

4. The electrode group as claimed in claim 1, wherein the cathode active material formed on the cathode current collector is Li₄Ti₅O₁₂.

5. The electrode group as claimed in claim 1, wherein the anode active material formed on the anode current collector is complex metal oxide.

6. The electrode group as claimed in claim 5, wherein the anode active material formed on the anode current collector is LiNiCoMnO₂ or LiMn₂O₄

7. The electrode group as claimed in claim 1, wherein position and size of the anode extending portions and the cathode extending portions can be adjusted according to different design requirements.

8. The electrode group as claimed in claim 1, wherein the electrode group is used for an oval lithium ion battery or a prismatic lithium ion battery.
